(19) United States
(12) Patent Application Publication
(10) Pub. No.: US 2014/0106087 A1
(43) Pub. Date: Apr. 17, 2014

(54) LASER CLADDING WITH THERMAL TRACING

(71) Applicants: Ronald L. Souther, Campobello, SC (US); Stuart Craig Hanson, Anderson, SC (US)

(72) Inventors: Ronald L. Souther, Campobello, SC (US); Stuart Craig Hanson, Anderson, SC (US)

(73) Assignee: GENERAL ELECTRIC COMPANY, Schenectady, NY (US)

(21) Appl. No.: 13/652,872

(22) Filed: Oct. 16, 2012

(51) Int. Cl. B05D 7/14; B05C 9/14

(52) U.S. Cl. 427/596; 118/641

(57) ABSTRACT

A laser cladding system may be configured with a laser cladding component configured to clad a first area of an article and a thermal tracing component configured to heat a second area of the article. The second area may be proximate to the first area.

### TECHNICAL FIELD

The present disclosure relates to laser cladding generally and in particular to methods and systems for laser cladding with thermal tracing to improve surface properties.

### BACKGROUND

Gas turbines, which may also be referred to as combustion turbines, are internal combustion engines that accelerate gases, forcing the gases into a combustion chamber where heat is added to increase the volume of the gases. The expanded gases are then directed towards a turbine to extract the energy generated by the expanded gases. Gas turbines have many practical applications, including use as jet engines and in industrial power generation systems.

Among the components of many gas turbines may be an impeller, which is a rotor configured inside a gas turbine to compress air pressure (e.g., a compressor impeller) in a combustion changer of the gas turbine. Like virtually all components of a gas turbine, impellers are subject to extreme operational environment conditions and subject to wear and breakage. Such components are inspected at regular intervals to determine whether repair or replacement is necessary. Upon discovery of a flaw in an impeller, such as a crack or excessive thinning and/or wear of the material from which the impeller is constructed, a repair may be made. In the current state of the art, the gas turbine must be at least partially disassembled for repair. Typically the repair consists of removing the impeller from the gas turbine, cladding the impeller with filler material, heat treating the impeller (e.g., by placing the impeller in a furnace), machining the impeller as needed to bring the dimensions of the impeller into specification, inspecting the impeller, and then placing it back into the gas turbine for service. As will be appreciated, this process removes the affected gas turbine from service for an extended period of time and therefore costs the operator money in lost time and productivity.

### BRIEF DESCRIPTION OF THE INVENTION

In an exemplary non-limiting embodiment, a laser cladding system is disclosed that may include a laser cladding component configured to clad a first area of an article and a thermal tracing component configured to heat a second area of the article. The second area may be proximate to the first area.

In another exemplary non-limiting embodiment, a method is disclosed for laser cladding an article. Cladding may be performed at a first area of the article with a laser cladding component. Heating a second area of the article may be performed with a thermal tracing component. The second area may be proximate to the first area.

The foregoing summary, as well as the following detailed description, is better understood when read in conjunction with the drawings. For the purpose of illustrating the claimed subject matter, there is shown in the drawings examples that illustrate various embodiments; however, the invention is not limited to the specific systems and methods disclosed.

### BRIEF DESCRIPTION OF THE DRAWINGS

These and other features, aspects, and advantages of the present subject matter will become better understood when the following detailed description is read with reference to the accompanying drawings, wherein:

FIG. 1 is a diagram of a non-limiting exemplary impeller portion of a gas turbine.

FIGS. 2A-2D are non-limiting examples of a defect area, a laser cladding area, and heat treatment areas according to embodiments disclosed herein.

FIG. 3 is a non-limiting exemplary method of laser cladding and heat treating according to the present disclosure.

FIG. 4 is an exemplary block diagram representing a general purpose computer system in which aspects of the methods and systems disclosed herein may be incorporated.

### DETAILED DESCRIPTION OF THE INVENTION

In an embodiment, laser beam cladding with filler material may be used to repair cracks or otherwise supplement any other areas of an impeller that may be determined to have excessive thinning or wear. Thermal tracing may be performed at or proximate to the repaired area of the impeller to relieve any stresses that may occur in the existing and/or filler material. Any type of material may be used to contrast the impeller and any type of material may be used as the filler material, and it is contemplated that the existing impeller material and the filler material may be the same or different. In an embodiment, either or both materials may be stainless steel. The contemplated thermal tracing procedures may use one or more radiant heating sources, induction heating, or any other type of heating source or means to achieve desired properties of the affected materials before and/or after cladding.

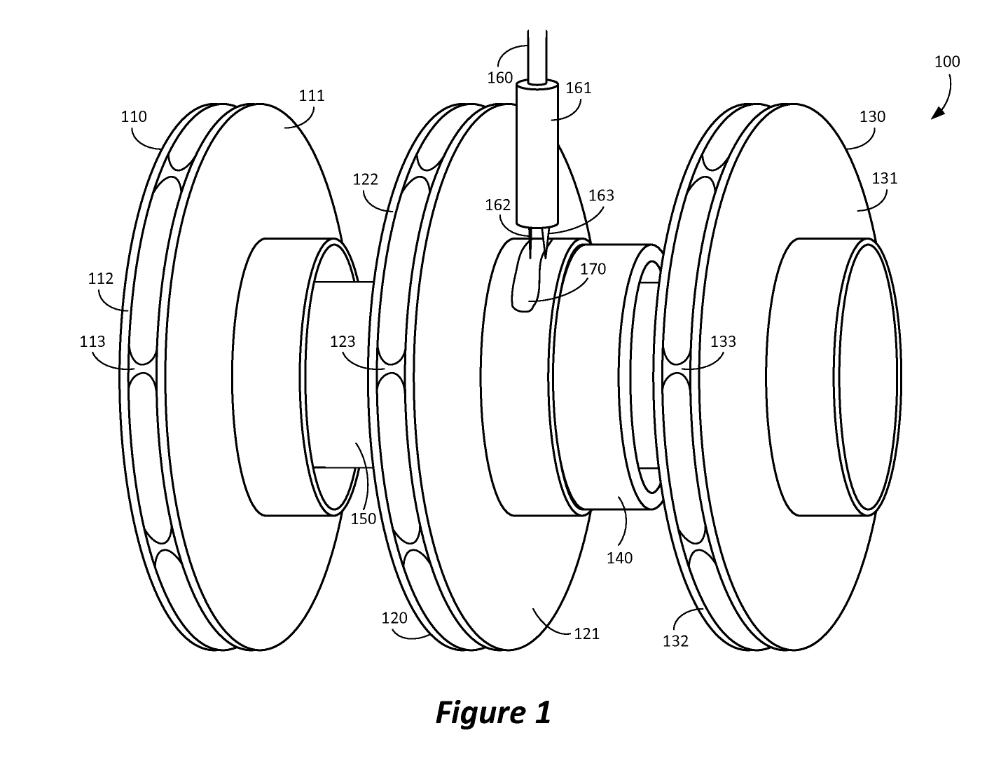

FIG. 1 illustrates exemplary impeller section 100 that may be any section of any gas turbine that includes one or more impellers. Note that FIG. 1 is a simplified drawing showing only those parts and components that may be useful in describing the present disclosure, and any other parts or components may be present in any embodiment. Impeller section 100 may include impeller 110 that may be configured with disk 111, counter-disk 112, and blades 113. Similarly, impeller 120 may be configured with disk 121, counter-disk 122, and blades 123. Likewise, impeller 130 may be configured with disk 131, counter-disk 132, and blades 133. Impellers 110, 120, and 130 may be configured within a gas turbine and may be connected by, otherwise attached to, or otherwise configured to rotate about shaft 150.

As the present disclosure allows for repair of defects in an impeller without complete disassembly of a gas turbine, and more specifically, without disassembly of an impeller section such as section 100, other components in or proximate to impeller section 100 may remain in place as repair is effected, such as chill block 140. As will be appreciated, by allowing repair of an impeller while it remains within a gas turbine and without requiring disassembly of the impeller section, the time and expense required for such a repair may be greatly reduced.

In an embodiment, laser cladding component 160 may be used to clad area 170 of impeller 120. Laser cladding component 160 may be configured with head 161 that may be configured to perform either laser cladding or thermal tracing, or both. For example head 161 may be configured to perform laser cladding. Head 161 may be removably attached to laser cladding component 160 and may be removed from laser cladding component 160 and replaced with another head that may be configured to perform thermal tracing. Alternatively, head 161 may be configured with components that enable it to perform both laser cladding and thermal tracing. The movement and operation of laser cladding component 160 may be fully or partially automated and may be implemented with the assistance of or under the control of one or more computing devices. All such embodiments, and any variation thereof, are contemplated as within the scope of the present disclosure.

In an embodiment, head 161 may emit laser 162 to perform laser cladding at area 170. Material may be deposited by head 161 or by any other means. The processes and procedures that may be used to perform laser cladding are well known to those skilled in the art, and therefore will not be described in detail herein. All means and methods of performing laser cladding are contemplated as within the scope of the present disclosure. Following the cladding process, thermal tracing may be performed through the use of head 161, which may be replaced to perform thermal tracing or may be configured to perform both thermal tracing and laser cladding. Head 161 may emit radiant heat 163 in order to heat area 170, an area proximate to area 170, an area immediately surrounding area 170, or a sub-area within area 170. The particular temperature of radiant heat 163 may be determined based, at least in part, on the material used for the cladding and/or the original material from which impeller 120 was constructed. The thermal tracing performed may restore the material properties to a desired hardness.

In an alternative embodiment, rather than providing a radiant heat source, head 161 may be configured to perform induction heating. Thus, head 161 may be configured with components that enable it to create an eddy current within impeller 120 that, due to the resistant properties of impeller 120, results in the heating of the material of impeller 120. Induction heating may allow for high power densities and therefore short heating times to reach a desired temperature. Induction heating may also allow precise control of the induced heating pattern, thereby enabling head 161 to trace a very specific area, whether that is area 170 or an area proximate to area 170, an area immediately surrounding area 170, or a sub-area within area 170. Note that because impellers may be made of electrically conductive materials, such as stainless steel or other metals, induction heating may be a convenient means to heat impeller material following, or in conjunction with, laser cladding. Note also that heating of impeller material, regardless of the means of doing so, may instead, or also, be performed before laser cladding so that the base material is in better condition for laser cladding.

In an embodiment, thermal tracing as described herein may be performed without laser cladding. In such an embodiment, head 161 may be used to heat area 170, using any heating means, to bring the properties of the impeller material in area 170 to a desired hardness without performing laser cladding before or after heat treatment. This ontongeneous process may be used to further harden materials of any article without adding filler material.

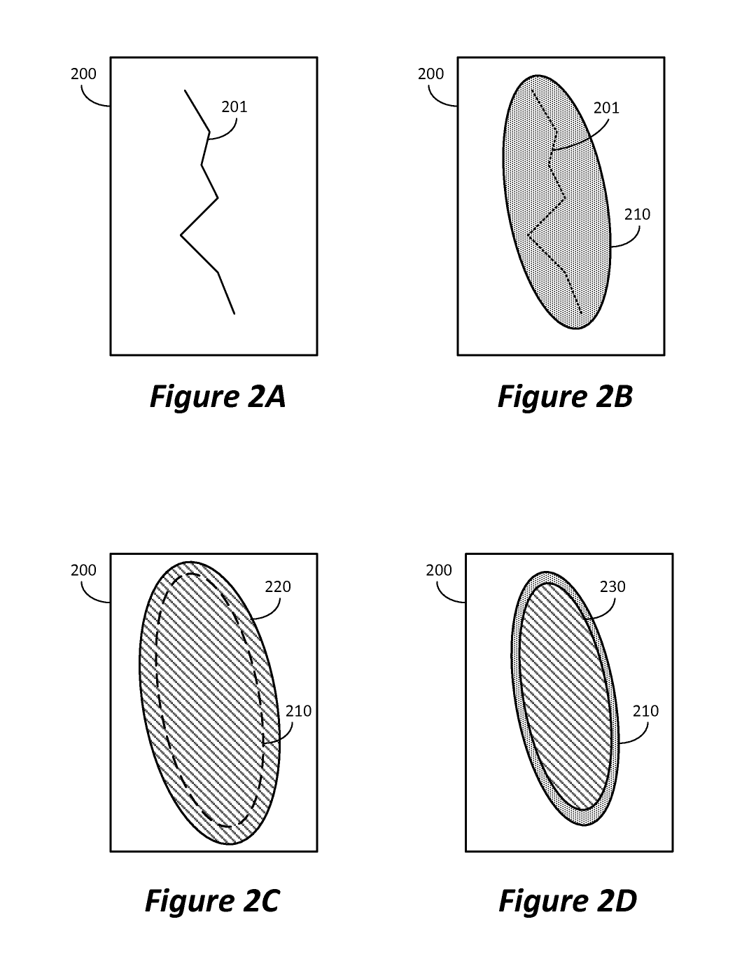

FIGS. 2A-2D illustrate an exemplary area that may be repaired using the disclosed laser cladding and thermal tracing embodiments. Note that these figures are simplified drawings showing only those parts and components that may be useful in describing the present disclosure, and any other parts or components may be present in any embodiment. Item 200 in FIG. 2A may be a section or an entire item that may be repaired using the present embodiments. For example, item 200 may be the subsection of impeller 120 in FIG. 1 that includes area 170 of FIG. 1. Item 200 may be damaged or in need of a repair. For example, crack 201 may be present in item 200. Crack 201 in FIG. 2 represents any type of crack, or any other type of defect, such as an area of excessive wear or material thinness.

In FIG. 2B, area 210 has been laser clad in order to repair crack 201 (still shown in dashed line for reference, though now repaired). In FIG. 2C, area 220 may be heat treated using any of the thermal tracing embodiments disclosed herein. As shown in FIG. 2C, in an embodiment, area 220 treated with heat may overlap area 210 to ensure complete heat treatment of all relevant areas of item 200. Alternatively, as shown in FIG. 2D, area 230 may be heat treated using any of the thermal tracing embodiments disclosed herein. In this embodiment, area 230 treated with heat may be within area 210 to ensure appropriate heat treatment of all relevant areas of item 200 without using resources and time to treat portions of item 200 that are not in need of heat treatment by thermal tracing. In another embodiment, a heat treated area may be approximately the same as the area clad. In yet another embodiment, a heat treated area may be a include portions of a clad area, but not the entirety. For example, a perimeter of a specified width that overlaps an outermost portion of a clad area may be heat treated using thermal tracing. Any variations of these embodiments are contemplated as within the scope of the present disclosure.

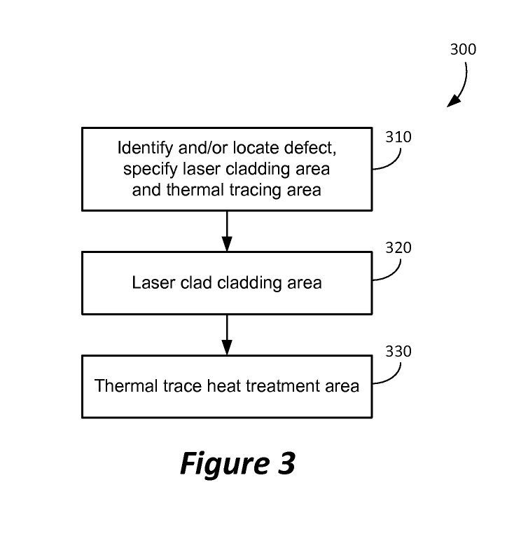

FIG. 3 illustrates exemplary, non-limiting method 300 of implementing an embodiment as disclosed herein. Method 300, and the individual actions and functions described in method 300, may be performed by any one or more devices, including those described herein. In an embodiment, any portion or all of method 300 may be performed by a device such as a computing device configured to operate a laser cladding device (e.g., laser cladding component 160) that may be configured to perform laser cladding and/or thermal tracing as set forth herein. Such a device may include several components, devices, systems, and/or subsystems, and in some embodiments may operate in conjunction with other devices and/or systems. Such a device may execute software configured on the device and/or executing on the device. Note that any of the functions and/or actions described in regard to any of the blocks of method 300 may be performed in any order, in isolation, with a subset of other functions and/or actions described in regard to any of the other blocks of method 300 or any other activities described herein, and in combination with other functions and/or actions, including those described herein and those not set forth herein. All such embodiments are contemplated as within the scope of the present disclosure.

At block 310, a defect may be identified and located. This may include identifying the defect using any means and receiving location data for the defect at a computing device configured to operate a laser cladding and thermal tracing system. The defect identified may be any defect that may warrant laser cladding and/or thermal tracing repair, such as, but not limited to, a crack, an area of excessive wear, and an area of excessively thin base material. Block 310 may also, or instead, include specifying or identifying an area to be laser clad that is distinct from the area of the defect. For example, the laser clad area may be larger than and completely cover the defect area. This may include specifying the cladding area using any means and receiving location data for the cladding area at a computing device configured to operate a laser cladding and thermal tracing system. Block 310 may also, or instead, include specifying or identifying an area to be heat treated using thermal tracing that is distinct from the area of the defect and/or the area to be clad. For example, the specified heat treatment area may be larger than and completely cover the cladding area and/or the determined defect area. This may include specifying the heat treatment area using any means and receiving location data for the heat treatment area at a computing device configured to operate a laser cladding and thermal tracing system. Any other information that may be used in performing any embodiment disclosed herein may be identified, determined, and/or received at block 310.

At block 320, laser cladding may be performed at the area specified for receiving such cladding at block 310 using any cladding means or methods. At block 330, the specified heat treatment area may be thermally traced using any means or methods, including induction heating and use of one or more radiant heat sources.

The technical effect of the systems and methods set forth herein is more efficient repair of gas turbine components and any other article that may be laser clad. As will be appreciated by those skilled in the art, the use of the disclosed processes and systems may reduce the time for repair by eliminating the need to disassemble portions of a gas turbine that contain parts to be repaired. As will further be appreciated, the disclosed systems and methods may be used to repair other part and components, including those not configured in a gas turbine, in a more efficient and cost effective manner. All such applications of the disclosed embodiments are contemplated as within the scope of the present disclosure.

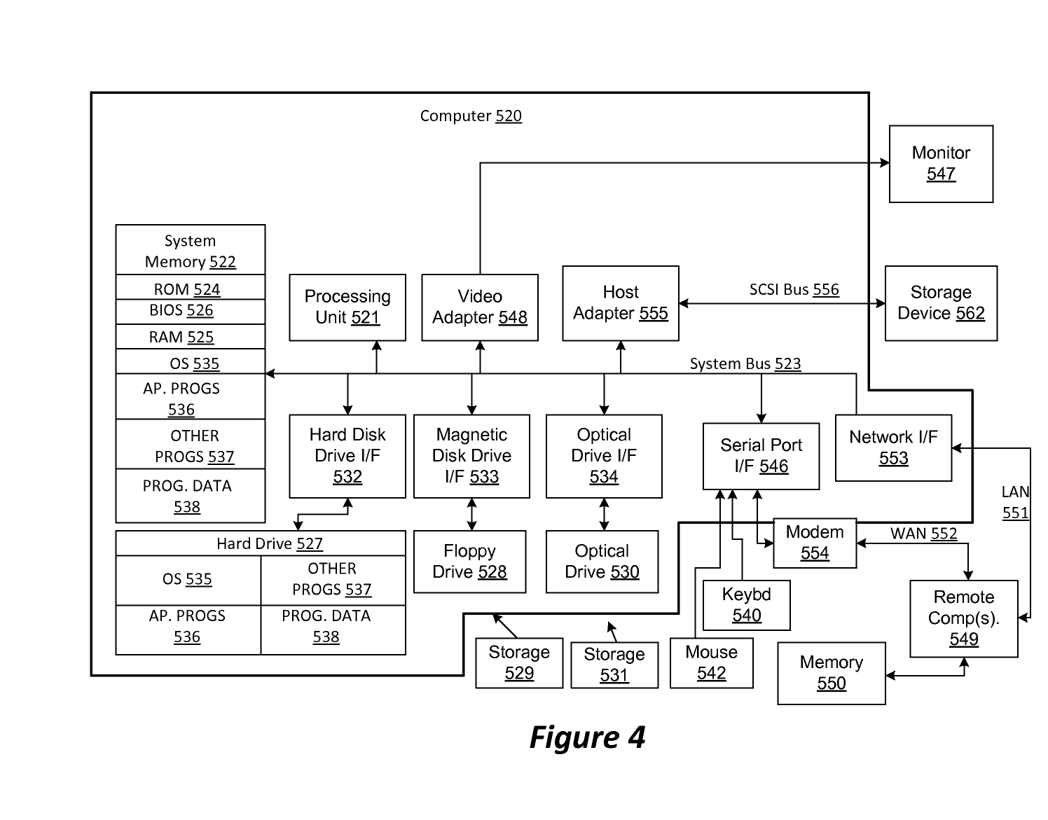

FIG. 4 and the following discussion are intended to provide a brief general description of a suitable computing environment in which the methods and systems disclosed herein and/or portions thereof may be implemented. For example, control of a thermal tracing and/or laser cladding system may be performed by one or more devices that include some or all of the aspects described in regard to FIG. 4. Although not required, the methods and systems disclosed herein may be described in the general context of computer-executable instructions, such as program modules, being executed by a computer, such as a client workstation, server or personal computer. Such computer-executable instructions may be stored on any type of computer-readable storage device that is not a transient signal per se. Generally, program modules include routines, programs, objects, components, data structures and the like that perform particular tasks or implement particular abstract data types. Moreover, it should be appreciated that the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 4 is a block diagram representing a general purpose computer system in which aspects of the methods and systems disclosed herein and/or portions thereof may be incorporated. As shown, the exemplary general purpose computing system includes computer 520 or the like, including processing unit 521, system memory 522, and system bus 523 that couples various system components including the system memory to processing unit 521. System bus 523 may be any of several types of bus structures including a memory bus or memory controller, a peripheral bus, and a local bus using any of a variety of bus architectures. The system memory may include read-only memory (ROM) 524 and random access memory (RAM) 525. Basic input/output system 526 (BIOS), which may contain the basic routines that help to transfer information between elements within computer 520, such as during start-up, may be stored in ROM 524.

Computer 520 may further include hard disk drive 527 for reading from and writing to a hard disk (not shown), magnetic disk drive 528 for reading from or writing to removable magnetic disk 529, and optical disk drive 530 for reading from or writing to removable optical disk 531 such as a CD-ROM or other optical media. Hard disk drive 527, magnetic disk drive 528, and optical disk drive 530 may be connected to system bus 523 by hard disk drive interface 532, magnetic disk drive interface 533, and optical drive interface 534, respectively. The drives and their associated computer-readable media provide non-volatile storage of computer readable instructions, data structures, program modules and other data for computer 520.

Although the exemplary environment described herein employs a hard disk, removable magnetic disk 529, and removable optical disk 531, it should be appreciated that other types of computer readable media that can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on hard disk drive 527, magnetic disk 529, optical disk 531, ROM 524, and/or RAM 525, including an operating system 535, one or more application programs 536, other program modules 537 and program data 538. A user may enter commands and information into the computer 520 through input devices such as a keyboard 540 and pointing device 542. Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device may also be connected to the system bus 523 via an interface, such as a video adapter 548. In addition to the monitor 547, a computer may include other peripheral output devices (not shown), such as speakers and printers. The exemplary system of FIG. 4 may also include host adapter 555, Small Computer System Interface (SCSI) bus 556, and external storage device 562 that may be connected to the SCSI bus 556.

The computer 520 may operate in a networked environment using logical connections to one or more remote computers, such as remote computer 549. Remote computer 549 may be a personal computer, a server, a router, a network PC, a peer device or other common network node, and may include many or all of the elements described above relative to the computer 520, although only a memory storage device 550 has been illustrated in FIG. 4. The logical connections depicted in FIG. 4 may include local area network (LAN) 551 and wide area network (WAN) 552. Such networking environments are commonplace in offices, enterprise-wide computer networks, intranets, and the Internet.

When used in a LAN networking environment, computer 520 may be connected to LAN 551 through network interface or adapter 553. When used in a WAN networking environment, computer 520 may include modem 554 or other means for establishing communications over wide area network 552, such as the Internet. Modem 554, which may be internal or external, may be connected to system bus 523 via serial port interface 546. In a networked environment, program modules depicted relative to computer 520, or portions thereof, may be stored in a remote memory storage device. It will be appreciated that the network connections shown are exemplary and other means of establishing a communications link between computers may be used.

Computer 520 may include a variety of computer-readable storage media. Computer-readable storage media can be any available tangible media that can be accessed by computer 520 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computer 520. Combinations of any of the above should also be included within the scope of computer-readable media that may be used to store source code for implementing the methods and systems described herein. Any combination of the features or elements disclosed herein may be used in one or more embodiments.

This written description uses examples to disclose the subject matter contained herein, including the best mode, and also to enable any person skilled in the art to practice the invention, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A laser cladding system comprising:
a laser cladding component configured to clad a first area of an article; and
a thermal tracing component configured to heat a second area of the article, wherein the second area is proximate to the first area.

2. The laser cladding system of claim 1, wherein the laser cladding component and the thermal tracing component are removably attached to the laser cladding system.

3. The laser cladding system of claim 1, wherein the thermal tracing component comprises a radiant heat source.

4. The laser cladding system of claim 1, wherein the thermal tracing component is configured to perform induction heating.

5. The laser cladding system of claim 1, wherein the second area is substantially a same size and at a same location as the first area.

6. The laser cladding system of claim 1, wherein the second area is larger than the first area and the second area substantially overlaps the first area.

7. The laser cladding system of claim 1, wherein the second area is smaller than the first area and the first area substantially overlaps the second area.

8. The laser cladding system of claim 1, wherein the article comprises an impeller portion of the gas turbine.

9. The laser cladding system of claim 1, wherein the laser cladding component and the thermal tracing component are interchangeable components of the laser cladding system.

10. The laser cladding system of claim 1, wherein the laser cladding component is configured to clad the first area before the thermal tracing component is configured to heat the second area.

11. A method of laser cladding an article, comprising:
cladding a first area of the article with a laser cladding component; and
heating a second area of the article with a thermal tracing component, wherein the second area is proximate to the first area.

12. The method of claim 11, wherein the laser cladding component and the thermal tracing component are removably attached to a laser cladding system.

13. The method of claim 11, wherein the heating of the second area comprises heating the second area with a radiant heat source configured in the thermal tracing component.

14. The method of claim 11, wherein the heating of the second area comprises heating the second area with an induction heating component configured in the thermal tracing component.

15. The method of claim 11, wherein the second area is substantially a same size and at a same location as the first area.

16. The method of claim 11, wherein the second area is larger than the first area and the second area substantially overlaps the first area.

17. The method of claim 11, wherein the second area is smaller than the first area and the first area substantially overlaps the second area.

18. The method of claim 11, wherein the article comprises an impeller portion of the gas turbine.

19. The method of claim 11, wherein the laser cladding component and the thermal tracing component are interchangeable components of a laser cladding system.

20. The method of claim 11, wherein the cladding of the first area is performed before the heating of the second area.
